(19) United States
(12) Patent Application Publication
(10) Pub. No.: US 2026/0202889 A1
(43) Pub. Date: Jul. 16, 2026

(54) MANAGEMENT OF DATA STORAGE DEVICE POWER CONSUMPTION

(71) Applicant: Sandisk Technologies, Inc., Milpitas, CA (US)

(72) Inventors: Prerana Vilas Desale, Bangalore (IN); Praveen Kumar Boda, Bangalore (IN); Arshad Ebrahim, Bangalore (IN)

(21) Appl. No.: 19/022,787

(22) Filed: Jan. 15, 2025

(51) Int. Cl. G06F 1/20; G06F 1/3225

(52) U.S. Cl. CPC G06F 1/206; G06F 1/3225

(57) ABSTRACT

Methods and apparatus for thermal management in data storage devices are provided. One such data storage device (DSD) includes a non-volatile memory (NVM), and one or more processors coupled to the NVM. The processor(s) are configured to operate the DSD in a default power state, enable an autonomous power state transition (APST) timer, determine a temperature of the DSD, and determine whether the temperature of the DSD is equal to or greater than a throttling temperature threshold. If the temperature of the DSD is equal to or greater than the throttling temperature threshold, operation of the APST timer is continued, operation in the default power state is ceased, and the DSD is operated according to a thermal idle power state. If a duration of the APST timer expires, operation according to the thermal idle power state is ceased, and the DSD is operated in an APST configured low power state.

### FIELD

The subject matter described herein relates to data storage devices and controllers. More particularly, the subject matter relates, in some examples, to reducing data storage device power consumption at high temperatures.

### INTRODUCTION

Data storage devices, such as solid-state devices (SSDs), may generate a significant amount of heat during operation. In the case of SSDs, for example, a controller of an SSD may be instructed (e.g., by a host device) to execute a series of memory operations (e.g., read, write, etc.) with respect to one or more non-volatile memory devices (e.g., NAND Flash memory devices). Rapid execution of these memory operations to meet the performance demands of the host may cause excess heat to build up in the SSD. A high ambient temperature in the SSD may also contribute to the excess heat. Consequently, such excess heat may raise the temperature of the SSD to a temperature that causes damage to (and/or hinders the performance of) components of the SSD, and thereby negatively impact overall SSD performance.

Issues related to excessive heat have been addressed using different thermal throttling schemes. For example, a data storage device may implement various thermal throttling schemes when the temperature of the device exceeds predefined temperature limits. In particular, when the temperature of a non-volatile memory (e.g., NAND) of the data storage device exceeds a predefined temperature limit, the device may shut down and enter a sleep state. However, previous thermal throttling schemes, such as this, may consume more power than is needed and unnecessarily delay the servicing of host commands after the data storage device has cooled to a safe temperature. Thus, a scheme for better managing the data storage device's power consumption during thermal throttling at high temperatures may be helpful for ensuring all components of the data storage device are protected using a thermal protection mechanism while also optimizing power consumption and preventing unnecessary delay in servicing host commands.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One aspect of the disclosure provides a data storage device, including a non-volatile memory (NVM) and one or more processors coupled to the NVM. The one or more processors, individually or collectively, are configured to: operate the data storage device in a default power state; enable an autonomous power state transition (APST) timer with a preselected duration; determine a temperature of the data storage device while the data storage device is operated in the default power state; determine whether the temperature of the data storage device is equal to or greater than a throttling temperature threshold; responsive to a determination that the temperature of the data storage device is equal to or greater than the throttling temperature threshold: continue operation of the APST timer; cease operation of the data storage device in the default power state; and operate the data storage device according to a thermal idle power state; responsive to a determination that the preselected duration of the APST timer has expired: cease operation of the data storage device according to the thermal idle power state; and operate the data storage device in an APST configured low power state with a power consumption less than that of the thermal idle power state; receive a command from a host coupled to the data storage device while the data storage device is operated in the APST configured low power state; cease operation of the data storage device in the APST configured low power state after the command from the host is received; and operate the data storage device in the default power state after operation of the data storage device in the APST configured low power state has ceased.

In one aspect, the data storage device further includes at least one ambient temperature sensor coupled to the one or more processors and configured to detect an ambient temperature of the data storage device, wherein the one or more processors are further configured to: determine whether the ambient temperature is equal to or greater than an ambient temperature threshold; determine whether a command queue of the data storage device for storing host commands is empty; and determine whether the temperature of the data storage device is equal to or greater than the throttling temperature threshold responsive to a determination that: the ambient temperature is equal to or greater than the ambient temperature threshold; and the command queue is empty.

In one aspect, the data storage device further includes at least one component temperature sensor coupled to the one or more processors and configured to detect one or more component temperatures of one or more components of the data storage device, wherein the one or more processors configured to determine the temperature of the data storage device are configured to: determine a highest temperature among the one or more component temperatures; and determine the highest temperature to be the temperature of the data storage device.

One aspect of the disclosure provides a method for use with a data storage device including a non-volatile memory (NVM). The method includes operating the data storage device in a default power state; enabling an autonomous power state transition (APST) timer with a preselected duration; determining a temperature of the data storage device while the data storage device is operated in the default power state; determining whether the temperature of the data storage device is equal to or greater than a throttling temperature threshold; responsive to a determination that the temperature of the data storage device is equal to or greater than the throttling temperature threshold: continuing operation of the APST timer; ceasing operation of the data storage device in the default power state; and operating the data storage device according to a thermal idle power state; responsive to a determination that the preselected duration of the APST timer has expired: ceasing operation of the data storage device according to the thermal idle power state; and operating the data storage device in an APST configured low power state with a power consumption less than that of the thermal idle power state; receiving a command from a host coupled to the data storage device while the data storage device is operated in the APST configured low power state; ceasing operation of the data storage device in the APST configured low power state after the command from the host is received; and operating the data storage device in the default power state after operation of the data storage device in the APST configured low power state has ceased.

One aspect of the disclosure provides a data storage device including a non-volatile memory (NVM), means for operating the data storage device in a default power state, means for enabling an autonomous power state transition (APST) timer with a preselected duration, means for determining a temperature of the data storage device while the data storage device is operated in the default power state, means for determining whether the temperature of the data storage device is equal to or greater than a throttling temperature threshold, means, operative in response to a determination that the temperature of the data storage device is equal to or greater than the throttling temperature threshold, for continuing operation of the APST timer, for ceasing operation of the data storage device in the default power state, and for operating the data storage device according to a thermal idle power state, means, operative in response to a determination that the preselected duration of the APST timer has expired, for ceasing operation of the data storage device according to the thermal idle power state and for operating the data storage device in an APST configured low power state with a power consumption less than that of the thermal idle power state, means for receiving a command from a host coupled to the data storage device while the data storage device is operated in the APST configured low power state, means for ceasing operation of the data storage device in the APST configured low power state after the command from the host is received, means for operating the data storage device in the default power state after operation of the data storage device in the APST configured low power state has ceased, means for detecting an ambient temperature of the data storage device, and means for detecting one or more component temperatures of one or more components of the data storage device.

### BRIEF DESCRIPTION OF THE DRAWINGS

FIG. 1 is a schematic block diagram illustrating an exemplary data storage device (DSD) embodied as a solid-state device (SSD) or other data storage device (DSD) including one or more ambient temperature sensors, one or more component temperature sensors, and an SSD/DSD controller configured to control thermal management operations in accordance with some aspects of the disclosure.

FIG. 2 is a flowchart illustrating a method for thermal state management of a data storage device (DSD) or a solid state device (SSD) without autonomous power state transition (APST) integration in accordance with some aspects of the disclosure.

FIG. 3 is a flowchart illustrating a method for thermal state management of a data storage device (DSD) or a solid state device (SSD) with autonomous power state transition (APST) integration in accordance with some aspects of the disclosure.

FIG. 4 is a flowchart illustrating a method for thermal state management of a data storage device (DSD) or a solid state device (SSD) with autonomous power state transition (APST) integration in accordance with some aspects of the disclosure.

FIG. 5 is a schematic block diagram illustrating an exemplary data storage device configured in accordance with some aspects of the disclosure.

FIG. 6 is a schematic block diagram configuration for an exemplary data storage device configured in accordance with some aspects of the disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

The examples herein relate to data storage devices (DSDs) and to data storage controllers of the DSDs. In the main examples described herein, data is stored within non-volatile memory (NVM) arrays. In other examples, data may be stored in hard disk drives (HDD). DSDs with NVM arrays may be referred to as solid state devices (SSDs). Some SSDs use NAND flash memory, herein referred to as “NANDs.” A NAND is a type of non-volatile storage technology that does not require power to retain data. It exploits negative-AND, i.e., NAND, logic. For the sake of brevity, an SSD having one or more NAND dies will be used as a non-limiting example of a DSD below in the description of various embodiments. It is understood that at least some aspects described herein may be applicable to other forms of DSDs as well. For example, at least some aspects described herein may be applicable to phase-change memory (PCM) arrays, magneto-resistive random access memory (MRAM) arrays, and resistive random access memory (ReRAM) arrays.

### Overview

Thermal throttling at an SSD may be triggered when a composite temperature of the SSD exceeds a temperature threshold. In one aspect, when the composite temperature of the SSD is equal to or greater than an extreme thermal throttling (ETT) threshold, the SSD may enter a thermal idle power state and use a thermal idle duty cycle scheme to reduce the SSD temperature. In an example duty cycle scheme, the SSD may be operational for a percentage (e.g., 5%) of a duty cycle period and non-operational (at a low power state) for another percentage (e.g., 95%) of the duty cycle period. If the SSD operational phase of the duty cycle is relatively short in duration during the thermal idle power state, then temperature increase may be prevented and the SSD will eventually cool to a lower temperature. However, if duration of the SSD non-operational phase of the duty cycle during the thermal idle power state is relatively long and no wakeup mechanisms are implemented to shorten the non-operational phase, the SSD may not be able to serve pending host commands (e.g., host IO commands) for a prolonged amount of time, thereby negatively affecting SSD performance (e.g., reducing SSD performance). To address the problem described above, an aspect of the disclosure provides an improved thermal management technique that integrates autonomous power state transition (APST) as a wakeup mechanism to shorten the SSD non-operational phase of the duty cycle when a thermal idle duty cycle scheme is used to reduce SSD temperature.

### Exemplary Devices, Systems and Procedures

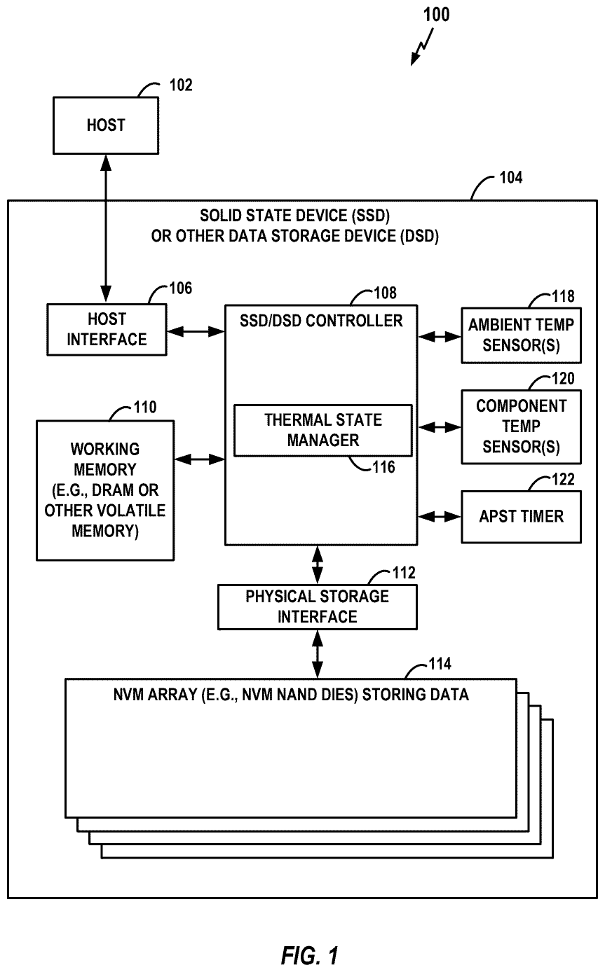

FIG. 1 is a schematic block diagram illustrating an exemplary data storage device (DSD) embodied as a solid-state device (SSD) or other data storage device (DSD) including one or more ambient temperature sensors, one or more component temperature sensors, and an SSD/DSD controller configured to control thermal management operations in accordance with some aspects of the disclosure. The system 100 includes a host 102 and the SSD 104 (or other DSD, but for simplicity referred to as an SSD below) coupled to the host 102. The host 102 provides commands to the SSD 104 for transferring data between the host 102 and the SSD 104. For example, the host 102 may provide a write command to the SSD 104 for writing data to the SSD 104 or read command to the SSD 104 for reading data from the SSD 104. The host 102 may be any system or device having a need for data storage or retrieval and a compatible interface for communicating with the SSD 104. For example, the host 102 may be a computing device, a personal computer, a portable computer, a workstation, a server, a personal digital assistant, a digital camera, or a digital phone as merely a few examples.

The SSD 104 includes a host interface 106, an SSD or DSD controller 108, a working memory 110 (such as DRAM or other volatile memory), a physical storage (PS) interface 112 (e.g., flash interface module (FIM)), and an NVM array 114 having one or more dies storing data. The host interface 106 is coupled to the controller 108 and facilitates communication between the host 102 and the controller 108. The controller 108 is coupled to the working memory 110 as well as to the NVM array 114 via the PS interface 112. The host interface 106 may be any suitable communication interface, such as a Non-Volatile Memory express (NVMe) interface, a Universal Serial Bus (USB) interface, a Serial Peripheral (SP) interface, an Advanced Technology Attachment (ATA) or Serial Advanced Technology Attachment (SATA) interface, a Small Computer System Interface (SCSI), an IEEE 1394 (Firewire) interface, or the like. In some embodiments, the host 102 includes the SSD 104. In other embodiments, the SSD 104 is remote from the host 102 or is contained in a remote computing system communicatively coupled with the host 102. For example, the host 102 may communicate with the SSD 104 through a wireless communication link. The NVM array 114 may include multiple dies.

In some examples, the host 102 may be a laptop computer with an internal SSD and a user of the laptop may wish to playback video stored by the SSD. In another example, the host again may be a laptop computer, but the video is stored by a remote server.

Although, in the example illustrated in FIG. 1, SSD 104 includes a single channel between controller 108 and NVM array 114 via physical storage (PS) interface 112, the subject matter described herein is not limited to having a single memory channel. For example, in some NAND memory system architectures, two, four, eight or more NAND channels couple the controller and the NAND memory device, depending on controller capabilities. In any of the embodiments described herein, more than a single channel may be used between the controller and the memory die, even if a single channel is shown in the drawings. The controller 108 may be implemented in a single integrated circuit chip and may communicate with different layers of memory in the NVM 114 over one or more command channels.

The controller 108 controls operation of the SSD 104. In various aspects, the controller 108 receives commands from the host 102 through the host interface 106 and performs the commands to transfer data between the host 102 and the NVM array 114. Furthermore, the controller 108 may manage reading from and writing to working memory 110 for performing the various functions effected by the controller and to maintain and manage cached information stored in the working memory 110.

The controller 108 may include any type of processing device, such as a microprocessor, a microcontroller, an embedded controller, a logic circuit, software, firmware, or the like, for controlling operation of the SSD 104. In some aspects, some or all of the functions described herein as being performed by the controller 108 may instead be performed by another element of the SSD 104. For example, the SSD 104 may include a microprocessor, a microcontroller, an embedded controller, a logic circuit, software, firmware, application specific integrated circuit (ASIC), or any kind of processing device, for performing one or more of the functions described herein as being performed by the controller 108. According to other aspects, one or more of the functions described herein as being performed by the controller 108 are instead performed by the host 102. In still further aspects, some or all of the functions described herein as being performed by the controller 108 may instead be performed by another element such as a controller in a hybrid drive including both non-volatile memory elements and magnetic storage elements.

The SSD controller 108 includes a thermal state manager 116, which can be configured to control a thermal operating state of the SSD 104 as will be described in further detail below. In one aspect, the thermal state manager 116 can determine an ambient temperature of the SSD 104 based on an ambient temperature detected by one or more ambient temperature sensors 118. The thermal state manager 116 can also determine a composite temperature of the SSD 104 based on the ambient temperature and one or more component temperatures detected by one or more component temperature sensors 120. In one aspect, the one or more component temperature sensors 120 may be coupled to the NVM array 114 and configured to detect the temperature of the NVM array 114. The one or more component temperature sensors 120 may also be coupled to various other components of the SSD 104 (e.g., controller 108, working memory 110, ASIC, etc.) and configured to detect the temperature of such components. In one aspect, the thermal state manager 116 can enable, disable, and/or maintain an autonomous power state transition (APST) of the SSD 104 based on a signal received from the host 104 and/or using an APST timer 122. In one aspect, the thermal state manager 116 is a module within the SSD controller 108 that is controlled by firmware. In one aspect, the thermal state manager 116 may be a separate component from the SSD controller 108 and may be implemented using any combination of hardware, software, and firmware (e.g., like the implementation options described above for SSD controller 108) that can perform thermal management as will be described in further detail below. In one example, the thermal state manager 116 is implemented using a firmware algorithm or other set of instructions that can be performed on the SSD controller 108 to implement the thermal management functions described below.

The working memory 110 may be any suitable memory, computing device, or system capable of storing data. For example, working memory 110 may be ordinary RAM, DRAM, double data rate (DDR) RAM, static RAM (SRAM), synchronous dynamic RAM (SDRAM), a flash storage, an erasable programmable read-only-memory (EPROM), an electrically erasable programmable ROM (EEPROM), or the like. In various embodiments, the controller 108 uses the working memory 110, or a portion thereof, to store data during the transfer of data between the host 102 and the NVM array 114. For example, the working memory 110 or a portion of the volatile memory 110 may be a cache memory. The NVM array 114 receives data from the controller 108 via the PS interface 112 and stores the data. In some embodiments, working memory 110 may be replaced by a non-volatile memory such as MRAM, PCM, ReRAM, etc. to serve as a working memory for the overall device.

The NVM array 114 may be implemented using NAND flash memory. In one aspect, the NVM array 114 may be implemented using any combination of NAND flash, PCM arrays, MRAM arrays, and/or ReRAM.

The PS interface 112 provides an interface to the NVM array 114. For example, in the case where the NVM array 114 is implemented using NAND flash memory, the PS interface 112 may be a flash interface module. In one aspect, the PS interface 112 may be implemented as a component of the SSD controller 108.

In the example of FIG. 1, the controller 108 may include hardware, firmware, software, or any combinations thereof that provide the functionality for the thermal state manager 116.

Although FIG. 1 shows an exemplary SSD and an SSD is generally used as an illustrative example in the description throughout, the various disclosed embodiments are not necessarily limited to an SSD application/implementation. As an example, the disclosed NVM array and associated processing components can be implemented as part of a package that includes other processing circuitry and/or components. For example, a processor may include, or otherwise be coupled with, embedded NVM array and associated circuitry. The processor could, as one example, off-load certain operations to the NVM and associated circuitry and/or components. As another example, the SSD controller 108 may be a controller in another type of device and still be configured to perform or control thermal state management and/or throttling, and perform some or all of the other functions described herein.

### Thermal State Management of Data Storage Device

In general, a composite temperature is an overall temperature of an SSD used to prevent damage to SSD components due to overheating. For example, the composite temperature may be used to warn of potential component damage and trigger/perform thermal protection mechanisms at the SSD, such as throttling and/or shutdown. The composite temperature may be visible to a host so that various thermal management actions (e.g., thermal protection mechanisms) performed by the SSD may occur at predictable and host-visible thresholds. In an aspect, the composite temperature is algorithmically determined by reading multiple temperature sensors placed at various locations within the SSD. That is, various temperature sensor readings may be combined in a function to generate the composite temperature. A temperature sensor may be located on a circuit board, within an integrated circuit (IC) of interest (e.g., the IC for which the temperature is monitored/measured), adjacent to the IC of interest, etc. For example, a temperature sensor may be located within an ASIC (e.g., SSD controller) or NAND. In another example, an external temperature sensor may be placed on the circuit board next to a NAND of interest (e.g., hottest NAND) under all conditions.

The composite temperature may be higher or lower than an actual reading of any individual sensor (for various components on the circuit board). Ideally, the composite temperature is within a range such that the components on the circuit board do not overheat, i.e., the components on the circuit board are not stressed due to heat. Moreover, the composite temperature may be recorded in various drive logs and reported through a NVMe Self-Monitoring Analysis and Reporting Technology (SMART) log and a System Management Bus (SMBus).

In one aspect, thermal throttling may be triggered when a composite temperature of the SSD exceeds a threshold (e.g., as defined by a host and/or SSD) due to a high host input/output (IO) workload and/or high ambient temperature. The SSD may be thermally throttled according to different throttling levels, such as light thermal throttling (LTT), heavy thermal throttling (HTT), and extreme thermal throttling (ETT). The different throttling levels may be triggered at different temperature thresholds. For example, LTT may be triggered when the composite temperature of the SSD is equal to or greater than 85 degrees C, HTT may be triggered when the composite temperature of the SSD is equal to or greater than 87 degrees C, and ETT may be triggered when the composite temperature of the SSD is equal or greater than 90 degrees C. Moreover, SSD power consumption may be reduced according to the level at which the SSD is throttled.

In one aspect, when the composite temperature of the SSD is equal to or greater than 90 degrees C triggering ETT, the SSD may enter a thermal idle power state and use a thermal idle duty cycle scheme (along with NVMe queue depth reduction) to reduce the SSD temperature. In an example duty cycle scheme, the SSD may be operational for 5% of a duty cycle period and non-operational (at a low power state) for 95% of the duty cycle period. Accordingly, if a duration of the duty cycle is 250 ms, then the SSD will be active for 13 ms of the duty cycle and asleep for 237 ms of the duty cycle. Because the SSD operational phase of the duty cycle is short (e.g., 13 ms) during the thermal idle power state, temperature increase is prevented and the SSD will eventually cool to a lower temperature. However, when the SSD is in the non-operational phase of the duty cycle during the thermal idle power state, PERST signals and/or thermal idle sleep wakeup timers might be the only sources to trigger SSD wakeup. (PERST stands for Peripheral Reset and may be, for example, a PCIe Reset Signal that is used to reset a PCIe device. The PERST signal may be configured as an active-low signal that the Host system asserts in scenarios requiring a reset.) As such, because the SSD non-operational phase of the duty cycle is relatively long (e.g., 237 ms), host IO commands may not be served for a prolonged amount of time thereby affecting the performance of the SSD. The SSD may continue to be in the thermal idle power state until the composite temperature of the SSD reaches an ETT exit threshold temperature (e.g., 87 degrees C).

To address the problem described above, an aspect of the disclosure provides an improved thermal management technique that integrates autonomous power state transition (APST) as a wakeup mechanism to shorten the SSD non-operational phase of the duty cycle when a thermal idle duty cycle scheme is used to reduce SSD temperature. (Although APST is a feature of NVMe, aspects of the present disclosure are not limited to NVMe. Rather, herein, APST refers more generally to any suitable autonomous power state transition procedure or mechanism.) For example, if ETT is triggered in the SSD (SSD composite temperature is equal to or greater than 90 degrees C) because of a high ambient temperature in the SSD (and no host IO workload), then the SSD may continuously be in the ETT state even though no host IO workload exists. To lower the SSD temperature, APST of the SSD may be triggered when no host IO workload exists. For example, APST may be triggered upon the expiration of an APST timer if no host IO commands are received (i.e., no host IO workload exists) by the time the APST timer expires. During APST, the SSD may enter one of various low power states, e.g., power state 3 (PS3), power state 4 (PS4 ), and power state 5 (PS5), wherein each power state may be active for a specific amount of time. For example, default APST time values for PS3, PS4, and PS5 may be 60 ms, 3 s, and 3 s, respectively. The SSD may wake up from a low power state upon the SSD receiving a host IO command.

Several advantages are provided by the improved technique. For example, the SSD will consume less power at higher ambient temperatures. Because SSD power consumption is lowered, device battery life will increase and SSD component temperatures (e.g., NVM, ASIC, etc.) will decrease. Moreover, the SSD will cool faster since the SSD is in a non-operational power state until a host sends a host command. The technique will also improve SSD performance/quality of service (QoS) by serving host IO commands at a faster rate, especially at high ambient temperatures.

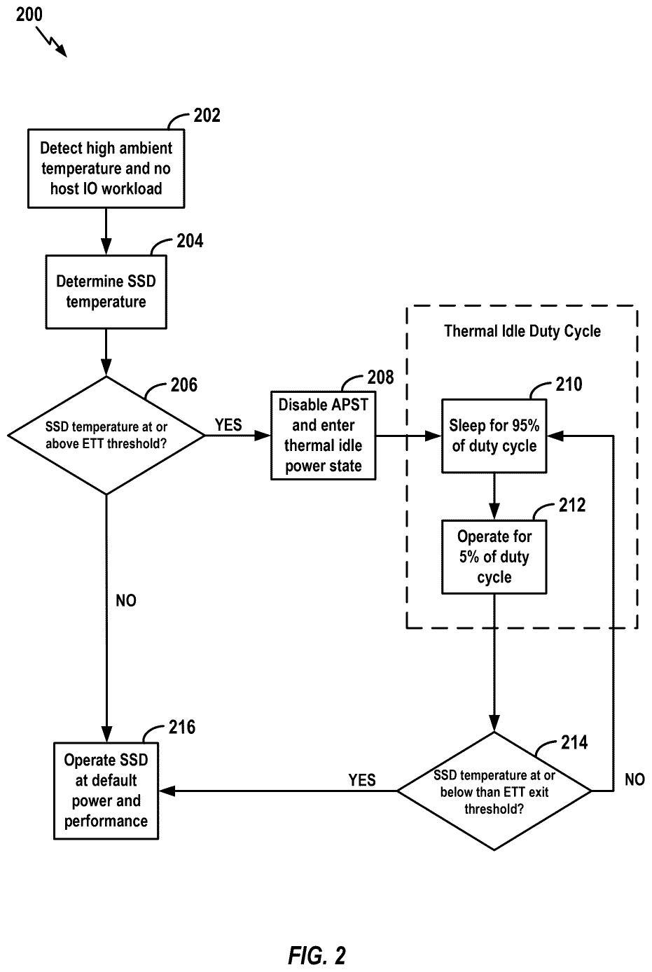

FIG. 2 is a flowchart illustrating a method 200 for thermal state management of a data storage device (DSD) or a solid state device (SSD) without autonomous power state transition (APST) integration in accordance with some aspects of the disclosure. The method may be performed by a controller of the DSD or SSD in accordance with some aspects of the disclosure. In one aspect, the method/process 200 may be performed by the SSD/DSD controller 108 (or thermal state manager 116) of FIG. 1, or any other suitably equipped device controller. Notably, prior to the process 200 being performed, the SSD controller may activate an APST timer (e.g., APST timer 122) to enable APST if no host IO commands are received (i.e., no host IO workload exists) before expiration of the timer. The duration of the APST timer may be configured by a host.

At block 202, the process detects a high ambient temperature (e.g., greater than or equal to 70 degrees C) of the SSD and that no host IO workload exists. For example, the ambient temperature may be detected via one or more ambient temperature sensors (e.g., ambient temperature sensor(s) 118 in FIG. 1). The process may detect the absence of the host IO workload based on the lack of host IO commands being received from the host.

At block 204, the process determines a temperature of the SSD (SSD temperature) when the high ambient temperature is detected and no host IO workload exists. The SSD temperature may be equivalent to the composite temperature of the SSD. Accordingly, the composite temperature of the SSD may be determined by first detecting one or more component temperatures of one or more components of the SSD. For example, the one or more component temperatures may be detected via one or more component temperature sensors (e.g., component temperature sensor(s) 120) positioned at or near a component of the SSD. SSD components may include a NVM array (e.g., NAND), a working memory, an ASIC, or any other type of electronic component housed within the SSD that produces heat. Thereafter, the process may determine a highest temperature among the detected one or more component temperatures to be the composite temperature, which is equivalent to the SSD temperature.

At block 206, the process determines whether the SSD temperature is equal to or greater than a temperature threshold (e.g., equal to or greater than 90 degrees C) to trigger ETT (ETT threshold). If the SSD temperature is below the temperature threshold to trigger ETT, then the process proceeds to block 216. At block 216, the process operates the SSD in a default power state and performance level. However, if the process determines that the SSD temperature is sufficient to trigger ETT, then the process proceeds to block 208.

At block 208, the process disables APST (e.g., by deactivating the previously activated APST timer) and enters a thermal power idle state. In the thermal idle power state, the process uses a thermal idle duty cycle scheme to reduce the SSD temperature. For example, a duty cycle may have a length of 250 ms. Accordingly, at block 210, the process operates the SSD at a low power state rendering the SSD non-operational (e.g., makes the SSD sleep) for 95% of the duty cycle. At block 212, the process enables the SSD to be operational (active) for 5% of the duty cycle. At the end of the duty cycle, the proceeds to block 214.

At block 214, the process determines whether the SSD temperature is equal to or less than a temperature threshold (e.g., 3 degrees below ETT threshold or 87 degrees C) to exit ETT (ETT exit threshold). If the SSD temperature is still greater than the ETT exit threshold, then the process proceeds back to block 210 to continue operating the SSD in the thermal idle power state. However, if the SSD temperature is equal to or less than the ETT exit threshold, then the process exits ETT and proceeds to block 216 to operate the SSD in the default power state and performance level.

As described above with reference to FIG. 2, at a high ambient temperature and with no host IO workload, the SSD may enter an ETT state and implement a thermal idle duty cycle scheme to lower the SSD temperature. However, because the thermal idle duty cycle scheme disables APST, an APST wakeup mechanism (e.g., reception of a host IO command) cannot be used to exit from a thermal idle power state. As a consequence, the SSD may frequently be in the thermal idle duty cycle, and thereby, SSD power consumption is increased as compared to a scheme enabling APST (and using an APST wakeup mechanism). For example, SSD power consumption using the thermal idle duty cycle scheme may be approximately 600 mW. In contrast, SSD power consumption using APST may be less than 15 mW. Thus, power savings may be considerable if an APST scheme is used as a wakeup source to exit from the ETT/thermal idle power state.

Notably, at a normal ambient temperature, the cooling rate of the SSD may be slow while exiting from the ETT state. Thus, the SSD may be in the thermal idle power state for a relatively long time even if there is no host IO workload. Because the thermal idle duty cycle scheme disables APST, the reception of a host IO command cannot be used as a wakeup source to exit from the thermal idle power state. As such, SSD performance will be negatively impacted because any received host IO commands will not be served for 95% of the duty cycle.

In one aspect, a SSD thermal state managing scheme is provided that enables APST and maintains activation of an APST timer during an ETT/thermal idle power state of the SSD. The SSD may use the expiry of the APST timer as a wakeup source to exit from the ETT/thermal idle power state, which facilitates reduced SSD power consumption and faster SSD cooling.

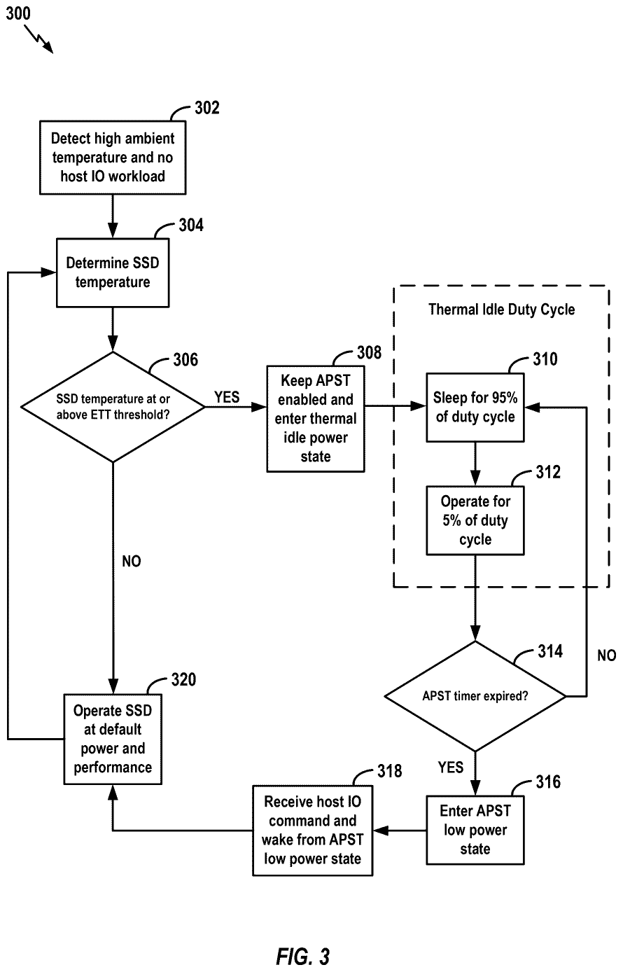

FIG. 3 is a flowchart illustrating a method 300 for thermal state management of a data storage device (DSD) or a solid state device (SSD) with autonomous power state transition (APST) integration in accordance with some aspects of the disclosure. The method may be performed by a controller of the DSD or SSD in accordance with some aspects of the disclosure. In one aspect, the method/process 300 may be performed by the SSD/DSD controller 108 (or thermal state manager 116) of FIG. 1, or any other suitably equipped device controller. Notably, prior to the process 300 being performed, the SSD controller may activate an APST timer (e.g., APST timer 122) to enable APST if no host IO commands are received (i.e., no host IO workload exists) before expiration of the timer. The duration of the APST timer may be configured by a host.

At block 302, the process detects a high ambient temperature (e.g., greater than or equal to 70 degrees C) of the SSD and that no host IO workload exists. For example, the ambient temperature may be detected via one or more ambient temperature sensors (e.g., ambient temperature sensor(s) 118 in FIG. 1). The process may detect the absence of the host IO workload based on the lack of host IO commands being received from the host.

At block 304, the process periodically determines a temperature of the SSD (SSD temperature) when the high ambient temperature is detected and no host IO workload exists. The SSD temperature may be equivalent to the composite temperature of the SSD. Accordingly, the composite temperature of the SSD may be determined by first detecting one or more component temperatures of one or more components of the SSD. For example, the one or more component temperatures may be detected via one or more component temperature sensors (e.g., component temperature sensor(s) 120) positioned at or near a component of the SSD. SSD components may include a NVM array (e.g., NAND), a working memory, an ASIC, or any other type of electronic component housed within the SSD that produces heat. Thereafter, the process may determine a highest temperature among the detected one or more component temperatures to be the composite temperature, which is equivalent to the SSD temperature.

At block 306, the process determines whether the SSD temperature is equal to or greater than a temperature threshold (e.g., equal to or greater than 90 degrees C) to trigger ETT (ETT threshold). If the SSD temperature is below the temperature threshold to trigger ETT, then the process proceeds to block 320. At block 320, the process operates the SSD in a default power state and performance level. However, if the process determines that the SSD temperature is sufficient to trigger ETT, then the process proceeds to block 308.

At block 308, the process keeps APST enabled by maintaining activation of the previously activated APST timer and enters a thermal idle power state. In the thermal idle power state, the process uses a thermal idle duty cycle scheme to reduce the SSD temperature. For example, a duty cycle may have a duration of 250 ms. Accordingly, at block 310, the process operates the SSD at a low power state rendering the SSD non-operational (e.g., makes the SSD sleep) for 95% of the duty cycle duration. At block 312, the process enables the SSD to be operational (active) for 5% of the duty cycle duration. At the end of the duty cycle, the proceeds to block 314.

At block 314, the process determines whether the APST timer has expired (i.e., no host IO commands are received during timer duration). If the APST timer has not expired, then the process proceeds back to block 310 to continue operating the SSD in the thermal idle power state. However, if the APST timer has expired, then process exits ETT and proceeds to block 316.

At block 316, the process enters the SSD into an APST configured low power state. For example, the process may enter the SSD into one of various low power states (e.g., PS3, PS4, or PS5), wherein each power state may be active for a specific amount of time (e.g., PS3 active for 60 ms, PS4 active for 3 s, and PS5 active for 3 s). Notably, by using the APST timer to exit the ETT state/thermal duty cycle, the SSD realizes reduced power consumption and faster cooling of the SSD as compared to exiting ETT without APST integration.

At block 318, the process wakes the SSD from the APST configured low power state when a host IO command is received from the host. The process then proceeds to block 320 to operate the SSD in the default power state and performance level. The process may thereafter proceed back to block 304 to continue periodically determining the SSD temperature when a high ambient temperature is detected and no host IO workload exists.

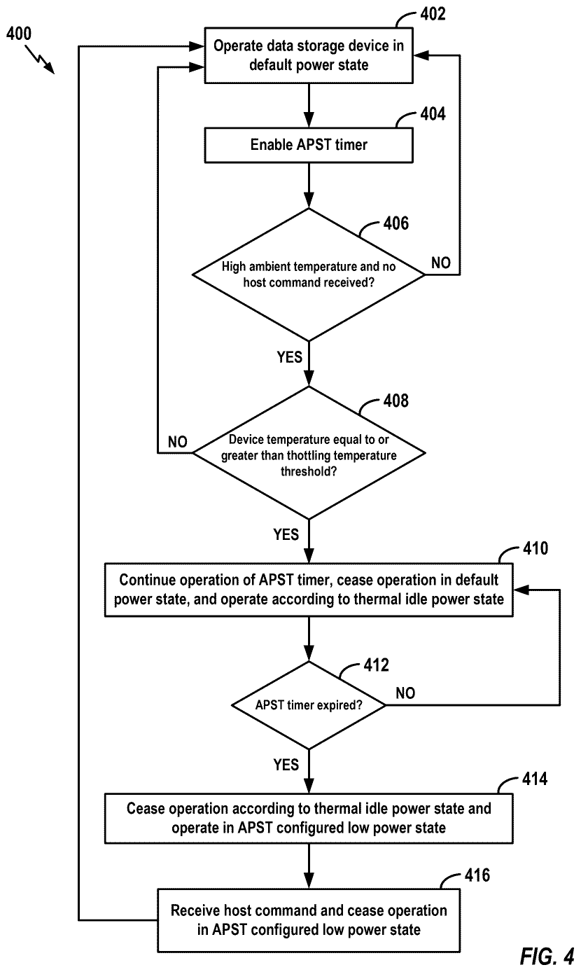

FIG. 4 is a flowchart illustrating a method 400 for thermal state management of a data storage device (DSD) or a solid state device (SSD) with autonomous power state transition (APST) integration in accordance with some aspects of the disclosure. The method may be performed by a controller of the DSD or SSD in accordance with some aspects of the disclosure. In one aspect, the method/process 400 may be performed by the SSD/DSD controller 108 (or thermal state manager 116) of FIG. 1, or any other suitably equipped device controller.

At block 402, the process operates the data storage device in a default power state and performance level. At block 404, the process enables an autonomous power state transition (APST) timer (e.g., APST timer 122) with a preselected duration. In one aspect, when the APST timer is enabled, the process will operate the data storage device according to an APST configured low power state if no commands from a host (e.g., host IO commands) coupled to the data storage device are received before the preselected duration of the APST timer expires. The preselected duration of the APST timer may be configured by the host.

At block 406, the process detects (via ambient temperature sensor(s) 118) an ambient temperature of the data storage device and determines whether the ambient temperature is equal to or greater than an ambient temperature threshold (e.g., greater than or equal to 70 degrees C). The process further determines (via host interface 106) whether a command from the host (host IO command) was received (e.g., determine whether host IO workload exists/determine whether a command queue for storing host commands is empty). If the ambient temperature is equal to or greater than the ambient temperature threshold and the command from the host was not received (e.g., command queue is empty), then the process proceeds to block 408.

At block 408, the process determines a temperature of the data storage device (device temperature) while the data storage device is operated in the default power state. The process further determines if the device temperature is equal to or greater than a throttling temperature threshold. For example, the process may determine whether the device temperature is equal to or greater than a temperature to trigger ETT (e.g., equal to or greater than 90 degrees C). If the device temperature is equal to or greater than the throttling temperature threshold, then the process proceeds to block 410.

In one aspect, the process determines the device temperature by detecting (via component temperature sensor(s) 120) one or more component temperatures of one or more components of the data storage device and determining a highest temperature among the one or more component temperatures. The process then determines the highest temperature to be the device temperature. In one aspect, the one or more components may include the NVM (NVM array 114) and/or one or more processors (e.g., ASIC) of the data storage device. In some aspects, the one or more component temperatures used to determine the temperature of the data storage device may include an ambient temperature of the data storage device. Accordingly, the ambient temperature may be detected via the ambient temperature sensor(s) 118 and/or the component temperature sensor(s) 120 positioned at or near a component of the data storage device selected to provide the ambient temperature of the data storage device.

At block 410, the process continues operation of the APST timer, ceases operation of the data storage device in the default power state, and operates the data storage device according to a thermal idle power state (or thermal idle duty cycle). In one aspect, operating the data storage device according to the thermal idle power state includes causing the data storage device to be non-operational for 95 percent of a duty cycle period and causing the data storage device to be operational for 5 percent of the duty cycle period. For example, the duty cycle period may be 250 ms.

At block 412, the process determines if the preselected duration of the APST timer has expired. The preselected duration of the APST timer may be configured by a host coupled to the data storage device. If the preselected duration of the APST timer has expired, then the process proceeds to block 414.

At block 414, the process ceases operation of the data storage device according to the thermal idle power state and operates the data storage device in an APST configured low power state with a power consumption less than that of the thermal idle power state. In one aspect, the APST configured low power state is a preconfigured power state (e.g., PS3, PS4, or PS5) that enables the data storage device to consume less power than the default power state.

At block 416, the process receives a command from the host coupled to the data storage device (e.g., host IO command) while the data storage device is operated in the APST configured low power state. After receiving the host command, the process ceases operation of the data storage device in the APST configured low power state and proceeds to block 402 to operate the data storage device in the default power state after operation of the data storage device in the APST configured low power state has ceased.

### Additional Exemplary Apparatus

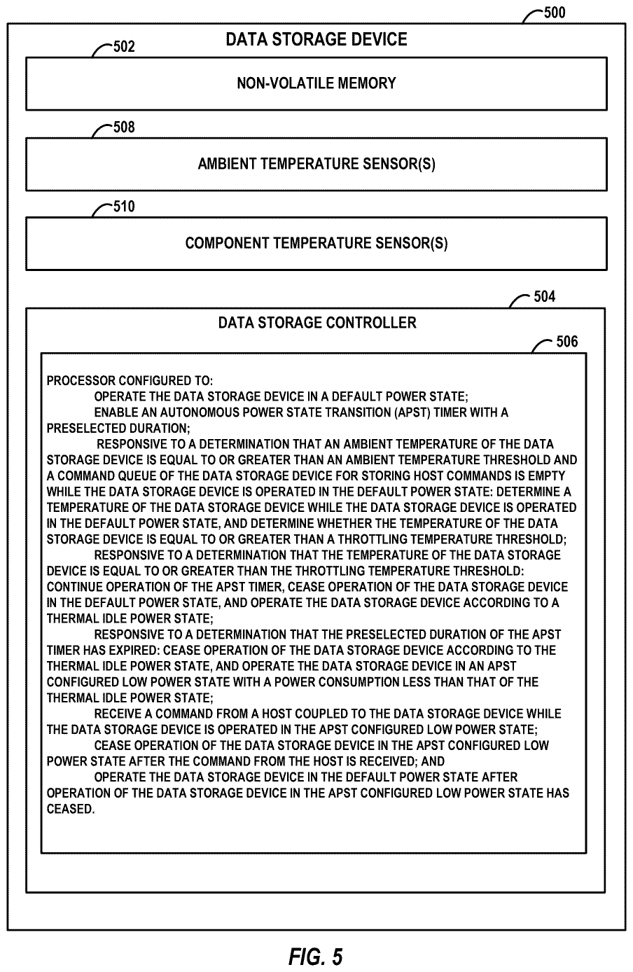

FIG. 5 broadly illustrates a data storage device 500 configured according to one or more aspects of the disclosure. The data storage device 500 includes a non-volatile memory (NVM) 502, one or more ambient temperature sensors 508, one or more component temperature sensors 510, and a data storage controller 504. The data storage controller 504 includes a processor or processing circuit 506 configured to: operate the data storage device in a default power state; enable an autonomous power state transition (APST) timer with a preselected duration; determine a temperature of the data storage device while the data storage device is operated in the default power state (via the one or more ambient temperature sensors 508 and the one or more component temperature sensors 510); determine whether the temperature of the data storage device is equal to or greater than a throttling temperature threshold; responsive to a determination that the temperature of the data storage device is equal to or greater than the throttling temperature threshold: continue operation of the APST timer, cease operation of the data storage device in the default power state, and operate the data storage device according to a thermal idle power state; responsive to a determination that the preselected duration of the APST timer has expired: cease operation of the data storage device according to the thermal idle power state, and operate the data storage device in an APST configured low power state with a power consumption less than that of the thermal idle power state; receive a command from a host coupled to the data storage device while the data storage device is operated in the APST configured low power state; cease operation of the data storage device in the APST configured low power state after the command from the host is received; and operate the data storage device in the default power state after operation of the data storage device in the APST configured low power state has ceased.

In one aspect, the processor 506 detects an ambient temperature of the data storage device (via the one or more ambient temperature sensors 508; determines whether the ambient temperature is equal to or greater than an ambient temperature threshold; determines whether a command queue of the data storage device for storing host commands is empty; and determines whether the temperature of the data storage device is equal to or greater than the throttling temperature threshold responsive to a determination that: the ambient temperature is equal to or greater than the ambient temperature threshold; and the command queue is empty.

In one aspect, to determine the temperature of the data storage device, the processor 506 detects one or more component temperatures of one or more components of the data storage device (via the one or more component temperature sensors 510); determines a highest temperature among the one or more component temperatures; and determines the highest temperature to be the temperature of the data storage device.

In one aspect, to operate the data storage device according to the thermal idle power state, the processor 506 causes the data storage device to be non-operational for 95 percent of a duty cycle period; and causes the data storage device to be operational for 5 percent of the duty cycle period.

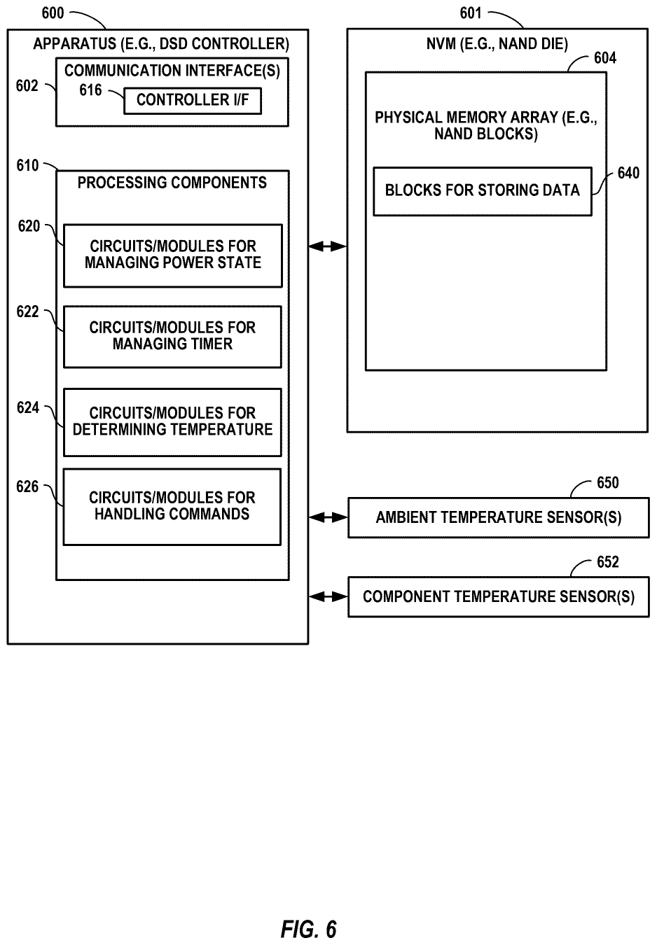

FIG. 6 illustrates an embodiment of an exemplary data storage device 600 configured according to one or more aspects of the disclosure. The apparatus 600, or components thereof, could embody or be implemented within a data storage controller such as a DSD controller coupled to a volatile memory (not shown), one or more ambient temperature sensors 650, one or more component temperature sensors 652, and a NAND die or some other type of NVM array that supports data storage. In various implementations, the apparatus 600, or components thereof, could be a component of a processor, a controller, a computing device, a personal computer, a portable device, workstation, a server, a personal digital assistant, a digital camera, a digital phone, an entertainment device, a medical device, a self-driving vehicle control device, an edge device, or any other electronic device that stores, processes, or uses data.

The apparatus 600 includes a communication interface 602 (including a controller interface 616) and is coupled to a NVM 601 (e.g., a NAND die). The NVM 601 includes physical memory array 604. The communication interface 602 is further coupled to the one or more ambient temperature sensors 650 and the one or more component temperature sensors 652. These components can be coupled to and/or placed in electrical communication with one another via suitable components, represented generally by the connection line in FIG. 6. Although not shown, other circuits such as timing sources, peripherals, voltage regulators, and power management circuits may be provided, which will not be described any further.

The communication interface 602 of the apparatus 600 provides a means for communicating with other apparatuses over a transmission medium. In some implementations, the communication interface 602 includes circuitry and/or programming (e.g., a program) adapted to facilitate the communication of information bi-directionally with respect to one or more devices in a system. In some implementations, the communication interface 602 may be configured for wire-based communication. For example, the communication interface 602 could be a bus interface, a send/receive interface, or some other type of signal interface including circuitry for outputting and/or obtaining signals (e.g., outputting signal from and/or receiving signals into a DSD).

The physical memory array 604 may include one or more NAND blocks 640. The physical memory array 604 may be accessed by the processing components 610.

In one aspect, the apparatus 600 may also include volatile memory for storing instructions and other information to support the operation of the processing components 610.

The apparatus 600 includes various processing components 610 arranged or configured to obtain, process and/or send data, control data access and storage, issue or respond to commands, and control other desired operations. For example, the processing components 610 may be implemented as one or more processors, one or more controllers, and/or other structures configured to perform functions. According to one or more aspects of the disclosure, the processing components 610 may be adapted to perform any or all of the features, processes, functions, operations and/or routines described herein. For example, the processing components 610 may be configured to perform any of the steps, functions, and/or processes described with respect to FIGS. 1-5. As used herein, the term “adapted” in relation to processing components 610 may refer to the components being one or more of configured, employed, implemented, and/or programmed to perform a particular process, function, operation and/or routine according to various features described herein. The circuits may include a specialized processor, such as an ASIC that serves as a means for (e.g., structure for) carrying out any one of the operations described, e.g., in conjunction with FIGS. 1-5. The processing components 610 serve as an example of a means for processing. In various implementations, the processing components 610 may provide and/or incorporate, at least in part, functionality described above for the components of controller 108 of FIG. 1 or controller 504 of FIG. 5.

According to at least one example of the apparatus 600, the processing components 610 may include one or more of: circuit/modules 620 configured for operating the data storage device in a default power state; ceasing operation of the data storage device in the default power state; operating the data storage device according to a thermal idle power state; ceasing operation of the data storage device according to the thermal idle power state; operating the data storage device in an APST configured low power state with a power consumption less than that of the thermal idle power state; ceasing operation of the data storage device in the APST configured low power state after the command from the host is received; and operating the data storage device in the default power state after operation of the data storage device in the APST configured low power state has ceased; circuit/modules 622 configured for enabling an autonomous power state transition (APST) timer with a preselected duration; and continuing operation of the APST timer; circuit/modules 624 configured for detecting an ambient temperature of the data storage device (e.g., via the one or more ambient temperature sensors 650); detecting one or more component temperatures of one or more components of the data storage device (e.g., via the one or more component temperature sensors 652); determining a temperature of the data storage device while the data storage device is operated in the default power state (e.g., via the one or more ambient temperature sensors 650 and/or the one or more component temperature sensors 652); and determining if the temperature of the data storage device is equal to or greater than a throttling temperature threshold; and circuit/modules 626 configured for determining whether a command from a host coupled to the data storage device is received (e.g., determining whether a command queue is empty); and receiving a command from a host coupled to the data storage device while the data storage device is operated in the APST configured low power state.

The physical memory array 604 may include blocks 640 for storing data.

In at least some examples, means may be provided for performing the functions illustrated in FIG. 6 and/or other functions illustrated or described herein. For example, the means may include one or more of: means, such as circuits/modules 620, for operating the data storage device 600 in a default power state, for ceasing operation of the data storage device 600 in the default power state, for operating the data storage device 600 according to a thermal idle power state, for ceasing operation of the data storage device 600 according to the thermal idle power state, for operating the data storage device 600 in an APST configured low power state with a power consumption less than that of the thermal idle power state, for ceasing operation of the data storage device 600 in the APST configured low power state after the command from the host is received, and for operating the data storage device 600 in the default power state after operation of the data storage device in the APST configured low power state has ceased; means, such as circuits/modules 622, for enabling an autonomous power state transition (APST) timer with a preselected duration, and for continuing of the APST timer; means, such as circuits/modules 624, for detecting an ambient temperature of the data storage device (e.g., via the one or more ambient temperature sensors 650), for detecting one or more component temperatures of one or more components of the data storage device (e.g., via the one or more component temperature sensors 652); for determining a temperature of the data storage device 600 while the data storage device 600 is operated in the default power state (e.g., via the one or more ambient sensors 650 and/or the one or more component temperature sensors 652), and for determining whether the temperature of the data storage device 600 is equal to or greater than a throttling temperature threshold; and means, such as circuits/modules 626, for determining whether a command from a host coupled to the data storage device 600 was received (e.g., for determining whether a command queue is empty), and for receiving a command from a host coupled to the data storage device 600 while the data storage device is operated in the APST configured low power state.

### ADDITIONAL ASPECTS

At least some of the processing circuits described herein may be generally adapted for processing, including the execution of programming code stored on a storage medium. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

At least some of the processing circuits described herein may be arranged to obtain, process and/or send data, control data access and storage, issue commands, and control other desired operations. The processing circuits may include circuitry configured to implement desired programming provided by appropriate media in at least one example. For example, the processing circuits may be implemented as one or more processors, one or more controllers, and/or other structure configured to execute executable programming. Examples of processing circuits may include a general purpose processor, a digital signal processor (DSP), an ASIC, a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. At least some of the processing circuits may also be implemented as a combination of computing components, such as a combination of a controller and a microprocessor, a number of microprocessors, one or more microprocessors in conjunction with an ASIC and a microprocessor, or any other number of varying configurations. The various examples of processing circuits noted herein are for illustration and other suitable configurations within the scope of the disclosure are also contemplated.

Aspects of the subject matter described herein can be implemented in any suitable NVM, including NAND flash memory such as 3D NAND flash memory. More generally, semiconductor memory devices include working memory devices, such as DRAM or SRAM devices, NVM devices, ReRAM, EEPROM, flash memory (which can also be considered a subset of EEPROM), ferroelectric random access memory (FRAM), and MRAM, and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured. The semiconductor memory elements located within and/or over a substrate may be arranged in two or three dimensions, such as a two-dimensional memory structure or a three-dimensional memory structure.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements. One of skill in the art will recognize that the subject matter described herein is not limited to the two-dimensional and three-dimensional exemplary structures described but cover all relevant memory structures within the spirit and scope of the subject matter as described herein and as understood by one of skill in the art.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatus, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state, or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” “in one aspect,” or similar language means that a particular feature, structure, or characteristic described in connection with the embodiment is included in at least one embodiment of the present disclosure. Thus, appearances of the phrases “in one embodiment,” “in an embodiment,” “in one aspect,” and similar language throughout this specification may, but do not necessarily, all refer to the same embodiment, but mean “one or more but not all embodiments” unless expressly specified otherwise.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” or “one or more of A, B, or C” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” or “one or more of A, B, or C” is intended to cover A, B, C, A-B, A-C, B-C, and A-B-C, as well as multiples of the same members (e.g., any lists that include AA, BB, or CC). Likewise, “at least one of: A, B, and C” or “one or more of A, B, or C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A data storage device, comprising:
a non-volatile memory (NVM); and
one or more processors coupled to the NVM, the one or more processors, individually or collectively, configured to:
operate the data storage device in a default power state;
enable an autonomous power state transition (APST) timer with a preselected duration;
determine a temperature of the data storage device while the data storage device is operated in the default power state;
determine whether the temperature of the data storage device is equal to or greater than a throttling temperature threshold; and
responsive to a determination that the temperature of the data storage device is equal to or greater than the throttling temperature threshold:
continue operation of the APST timer;
cease operation of the data storage device in the default power state; and
operate the data storage device according to a thermal idle power state.

2. The data storage device of claim 1, wherein responsive to a determination that the preselected duration of the APST timer has expired, the one or more processors are further configured to:
cease operation of the data storage device according to the thermal idle power state; and
operate the data storage device in an APST configured low power state with a power consumption less than that of the thermal idle power state.

3. The data storage device of claim 2, wherein the one or more processors are further configured to:
receive a command from a host coupled to the data storage device while the data storage device is operated in the APST configured low power state;
cease operation of the data storage device in the APST configured low power state after the command from the host is received; and
operate the data storage device in the default power state after operation of the data storage device in the APST configured low power state has ceased.

4. The data storage device of claim 2, wherein the APST configured low power state is a preconfigured power state in which the data storage device consumes less power than in the default power state.

5. The data storage device of claim 1, further comprising:
at least one ambient temperature sensor coupled to the one or more processors and configured to detect an ambient temperature of the data storage device,
wherein the one or more processors are further configured to:
determine whether the ambient temperature is equal to or greater than an ambient temperature threshold;
determine whether a command queue of the data storage device for storing host commands is empty; and
determine whether the temperature of the data storage device is equal to or greater than the throttling temperature threshold responsive to a determination that:
the ambient temperature is equal to or greater than the ambient temperature threshold; and
the command queue is empty.

6. The data storage device of claim 1, further comprising:
at least one component temperature sensor coupled to the one or more processors and configured to detect one or more component temperatures of one or more components of the data storage device,
wherein the one or more processors configured to determine the temperature of the data storage device are configured to:
determine a highest temperature among the one or more component temperatures; and
determine the highest temperature to be the temperature of the data storage device.

7. The data storage device of claim 6, wherein the one or more components comprises at least one of:
the NVM; or
the one or more processors.

8. The data storage device of claim 1, wherein the one or more processors configured to operate the data storage device according to the thermal idle power state are configured to:
cause the data storage device to be non-operational for 95 percent of a duty cycle period; and
cause the data storage device to be operational for 5 percent of the duty cycle period.

9. The data storage device of claim 1, wherein the preselected duration of the APST timer is configured by a host coupled to the data storage device.

10. A method for use with a data storage device comprising a non-volatile memory (NVM), the method comprising:
operating the data storage device in a default power state;
enabling an autonomous power state transition (APST) timer with a preselected duration;
determining a temperature of the data storage device while the data storage device is operated in the default power state;
determining whether the temperature of the data storage device is equal to or greater than a throttling temperature threshold; and
responsive to a determination that the temperature of the data storage device is equal to or greater than the throttling temperature threshold:
continuing operation of the APST timer;
ceasing operation of the data storage device in the default power state; and
operating the data storage device according to a thermal idle power state.

11. The method of claim 10, wherein responsive to a determination that the preselected duration of the APST timer has expired, the method further comprising:
ceasing operation of the data storage device according to the thermal idle power state; and
operating the data storage device in an APST configured low power state with a power consumption less than that of the thermal idle power state.

12. The method of claim 11, further comprising:
receiving a command from a host coupled to the data storage device while the data storage device is operated in the APST configured low power state;
ceasing operation of the data storage device in the APST configured low power state after the command from the host is received; and
operating the data storage device in the default power state after operation of the data storage device in the APST configured low power state has ceased.

13. The method of claim 11, wherein the APST configured low power state is a preconfigured power state in which the data storage device consumes less power than in the default power state.

14. The method of claim 10, further comprising:
detecting an ambient temperature of the data storage device;
determining whether the ambient temperature is equal to or greater than an ambient temperature threshold;
determining whether a command queue of the data storage device for storing host commands is empty; and
determining whether the temperature of the data storage device is equal to greater than the throttling temperature threshold responsive a determination that:
the ambient temperature is equal to or greater than the ambient temperature threshold; and
the command queue is empty.

15. The method of claim 10, wherein the determining the temperature of the data storage device comprises:
detecting one or more component temperatures of one or more components of the data storage device;
determining a highest temperature among the one or more component temperatures; and
determining the highest temperature to be the temperature of the data storage device.

16. The method of claim 15, wherein the one or more components comprises at least one of:
the NVM; or
the one or more processors.

17. The method of claim 10, wherein the operating the data storage device according to the thermal idle power state comprises:
causing the data storage device to be non-operational for 95 percent of a duty cycle period; and
causing the data storage device to be operational for 5 percent of the duty cycle period.

18. The method of claim 10, wherein the preselected duration of the APST timer is configured by a host coupled to the data storage device.

19. A data storage device comprising a non-volatile memory (NVM), comprising:
means for operating the data storage device in a default power state;
means for enabling an autonomous power state transition (APST) timer with a preselected duration;
means for determining a temperature of the data storage device while the data storage device is operated in the default power state;
means for determining whether the temperature of the data storage device is equal to or greater than a throttling temperature threshold; and
means, operative in response to a determination that the temperature of the data storage device is equal to or greater than the throttling temperature threshold, for continuing operation of the APST timer, for ceasing operation of the data storage device in the default power state, and for operating the data storage device according to a thermal idle power state.

20. The data storage device of claim 19, further comprising means, operative in response to a determination that the preselected duration of the APST timer has expired, for ceasing operation of the data storage device according to the thermal idle power state and for operating the data storage device in an APST configured low power state with a power consumption less than that of the thermal idle power state.
